(19) United States
(12) Patent Application Publication
(10) Pub. No.: US 2026/0187271 A1
(43) Pub. Date: Jul. 2, 2026

(54) THIRD-PARTY SERVICE ACCESS DASHBOARD

(71) Applicant: Wells Fargo Bank, N.A., San Francisco, CA (US)

(72) Inventors: William Blakely Belchee, Charlotte, NC (US); Keith Christopher Clithero, Charlotte, NC (US); Daniel Sanford, Charlotte, NC (US)

(21) Appl. No.: 19/007,527

(22) Filed: Jan. 1, 2025

(51) Int. Cl. G06F 21/62

(52) U.S. Cl. CPC G06F 21/6245; H04N 21/2547

(57) ABSTRACT

Systems and techniques may generally be used for monitoring access to customer account data. An example technique may include monitoring, using processing circuitry, access to customer account data by a third-party service, that is unrelated to the request from the customer. An example technique may also include presenting a user interface to the customer, including information about the access that is unrelated to the request from the customer, and presenting a control to change some or all access to multiple fields of customer data.

### BACKGROUND

Customers of account institutions may request that access to their account data be shared when registering with a third-party. For any of a number of different initial transactions, the customer may not realize that they permissioned the third-party service perpetual access to the customer data. The customer account data may be accessed at a later time, unrelated to the initial request from the customer.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates a system diagram concerning access to customer account data in accordance with some embodiments.

FIG. 1B illustrates a user interface concerning access to customer account data in accordance with some embodiments.

FIG. 2 illustrates a swim lane diagram concerning access to customer account data in accordance with some embodiments.

FIG. 3 illustrates a flowchart showing an example method concerning access to customer account data in accordance with some embodiments.

FIG. 4 illustrates generally an example of a block diagram of a machine upon which any one or more of the techniques discussed herein may perform in accordance with some embodiments.

### DETAILED DESCRIPTION

The systems and techniques described herein may be used to monitor access to customer account data by a third-party service, including monitoring access that is unrelated to a request from the customer. The systems and techniques described herein may be used to present a user interface to the customer, including information about the access.

Customers may request that access be provided to their account data to facilitate a particular transaction or a verification, etc. Customers often do not realize that the access they are granting for the particular transaction is broader than intended. The access that was granted may be used by whoever the access was granted to at a later date and/or for purposes unrelated to the original request. It is desired to provide the customer with information about access to their account data to better inform the customer about the access, such as who is accessing the data, when and how often, and what types of data are being accessed. It is also desired to enable the customer to change the access that was originally granted, if desired.

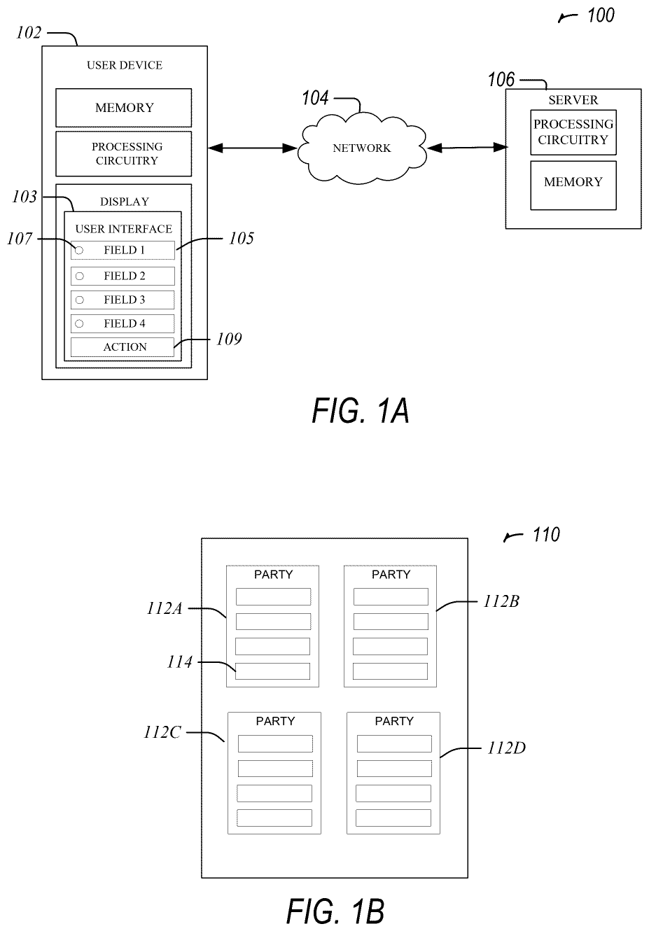

FIG. 1A illustrates a system diagram 100 for monitoring access to customer account data and presenting a user interface to the customer including information about access to the customer account data. The system diagram 100 illustrates a user device 102 in communication with a server 106 via a network 104 (e.g., the Internet). Examples of user devices 102 include, but are not limited to, mobile telephones, tablets, smart watches, laptop computers, desktop computers, etc. In one example, the user device 102 may include processing circuitry and memory to generate a customer request that involves customer account data. The request may be received at the server 106. In one example, the server 106 may include processing circuitry and memory to generate a user interface 103 at the user device 102. The user interface 103 may include multiple fields 105. In one example, the multiple fields 105 include selection options 107 that may be used to select or de-select individual fields 105.

After selecting one or more of the multiple fields 105 using selection options 107, an action button 109 may be used to act on the selected fields 105. Examples of actions effected by the action button 109 include, but are not limited to: “revoke access;” “suspend access;” “continue to allow access,” etc.

In one example, the multiple fields 105 include different types of customer data from an associated customer account. Examples of customer data fields 105 include, but are not limited to, account number, routing number, account balance, account balance history, payment recipients, payment recipient types (such as credit card payments, mortgage payments, etc.), payment amounts, payment dates, etc. Other examples of customer data fields 105 include, but are not limited to, payroll amounts, payroll sources, annual income, etc. Other examples of customer data fields 105 include, but are not limited to, customer name, customer address, customer social security number, customer family members and their information, customer phone number, number of accounts, types of accounts, etc. Other examples of customer data fields 105 include, but are not limited to, documents, such as proof of ownership documents, titles, etc.

FIG. 1B shows another example of a user interface 110, similar to user interface 103 from FIG. 1A. In the example of FIG. 1B, multiple displays 112A-112D are shown, with each of the multiple displays 112A-112D associated with a different third-party. Each of the multiple displays 112A-112D includes a number of individual customer data fields 114, similar to the customer data fields 105 discussed in examples above. In one example, the user interfaces 103, 110 shown in FIGS. 1A and 1B provide a customer with information about access being provided to different fields 105, 114 of their data for one or more different third-parties. The user interface 110 may provide information about different types of access for different third-parties.

As discussed above, in a first interaction, a customer may request that access be granted to their account data. The customer is likely aware of the access that is granted in relation to this request. In one example, the request includes a request to associate a customer account with a computer application (app). An example of a customer account includes a customer bank account. One example of a request to associate a customer account with an app includes a shopping app that may in turn store some or all of the account data in order to process purchases. Another example of a request to associate a customer account with an app includes a game app that may in turn store some or all of the account data in order to process in-game purchases. These examples include requests that facilitate payments, either at the time of the request, or at a later date.

Other requests may include requests of account status that may, or may not be associated with payments. In one example, the request includes a request for a bank to share account information to a third-party to secure a loan, such as a car loan, home mortgage, etc. In these examples, there is a customer request that is related to the access of customer account data (to facilitate a present or future payment, provide proof of funds, identification, etc.). Access to the customer account data is expected if it is related to the original request. Any of a number of metrics may be applied to determine if access to customer data is related to a customer request.

In one example, when a third-party accesses customer account data, the access is related to the customer request if it is temporally within a certain amount of time of the customer request. In one example, when a third-party accesses customer account data, the access is related to the customer request if the data accesses reasonably pertains to the customer request. For example, a customer's credit score reasonably pertains to a request for a mortgage application. However, an amount of a customer's annual income may not reasonably pertain to an in-app purchase for a phone game. In one example, all access may be monitored, and presented to the customer. The customer may then decide what access is related to a customer request, and what access is not related to the customer request. For example, access showing that video streaming services are making automatic payments from a customer's account may be expected, and related to a customer originally setting up automatic payments, however, other access apart from automatic payments may not be expected by the customer. Further, access by a video streaming service may be expected for monetary transfers, however, access to a customer's home address may not be expected, or access to a customer's employer name may not be expected. By presenting the customer with a more granular detail of access, the customer is better situated to decide which access to permit, and whether or not some access should be revoked.

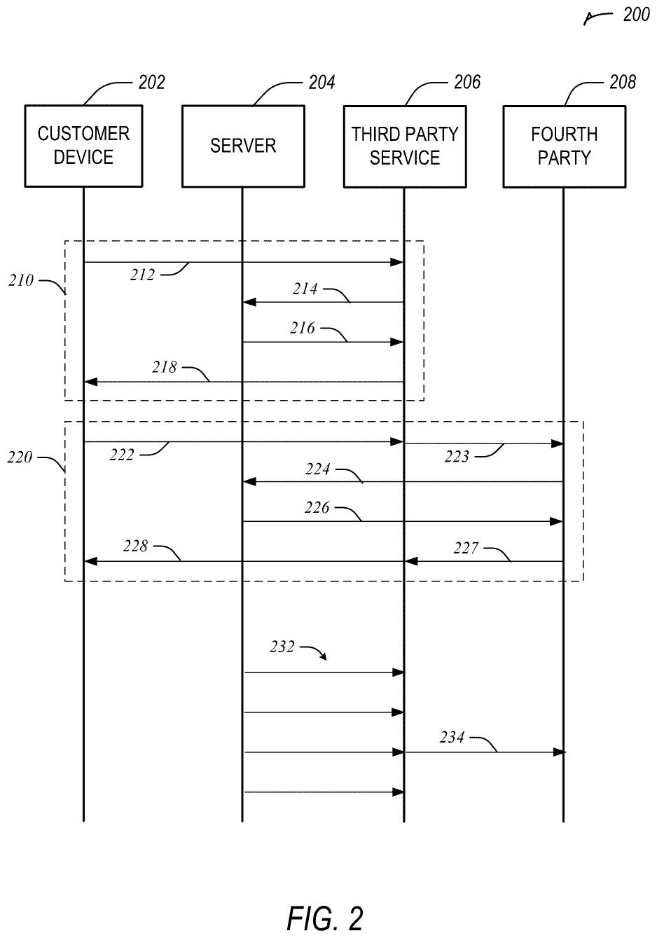

In one example, who is accessing the customer account data is further included in the user interface presented to the customer. FIG. 2 illustrates a swim lane diagram 200 showing interactions between a number of different parties. In one example, data from the swim lane diagram 200 is presented to a user interface to a customer, such as user interface 103 or 110 from FIGS. 1A and 1B. The swim lane diagram 200 illustrates interactions between and among a customer device 202, a server 204, a third-party service 206, and sometimes a fourth-party service 208.

A first interaction 210 is shown within a first dashed line perimeter. In the first interaction 210, a customer requests to a third-party service 206 that access be granted to their account data from the server 204. In the example of first interaction 210, the third-party may include a phone app, and the server 204 includes a bank where the customer has a bank account. The request in the first interaction 210 example includes a request to associate a bank account with the phone app to facilitate purchases.

The initial request 212 goes from the customer to the third-party 206. The third-party 206 then requests access 214 to the server 204 on behalf of the customer 202. The server 204 then sends the requested customer data 216 to the third-party 206, and the third-party 206 sends confirmation 218 to the customer 202 that the customer data has been received. In the example of the first interaction 210, all transmission of data along arrows 212, 214, 216, and 218 are related to the initial request 212.

A second interaction 220 is also shown within a second dashed line perimeter. In the second interaction 220, a customer again requests to a third-party service 206 that access be granted to their account data from the server 204. In the second interaction 220, the initial request 222 goes from the customer to the third-party 206. The third-party 206 then requests 223 to a fourth-party 208 that the fourth-party 208 coordinate the arrangement between the third-party 206 and the customer. Examples of fourth-party services include, but are not limited to, Plaid™ for phone apps, and Blend™ for lending and mortgages.

The fourth-party 208 then requests access 224 to the server 204 on behalf of the customer 202. The server 204 then sends the requested customer data 226 to the fourth-party 208, and the fourth-party 208 sends confirmation 227 back to the third-party 206 that the customer data has been received. In the second interaction 220, the third-party 206 then further sends confirmation 228 to the customer 202 that the customer data has been received. In the example of the second interaction 220, all transmission of data along arrows 222, 223, 224, 226, 227, and 228 are related to the initial request 220.

As noted above, a customer may not realize that the access granted to the third-party 206, or the fourth-party 208 was broader than they intended. In FIG. 2, additional access 232 of customer account data is shown, where the additional access 232 is unrelated to the first interaction 210 or the second interaction 220. Another example of additional access 234 is shown where the third-party 206 provides customer account data to the fourth-party 208 that is unrelated to the first interaction 210 or the second interaction 220.

In one example, some or all of the access shown in FIG. 2 is provided in a user interface to the customer, similar to the user interfaces 103, 110 from FIGS. 1A and 1B. In one example, the user interfaces 103, 110 include information about which accesses are related to a customer request, and which accesses are not related to a customer request. In one example, information about access to customer account data includes what categories of customer financial data from a plurality of categories are accessed. In one example, information about access to customer account data includes information about a duration of access by the third-party 206 and/or the fourth-party 208. In one example, information about access to customer account data includes information about a number of access instances per time period by the third-party 206 and/or the fourth-party 208. In one example, information about access to customer account data includes information about an amount of data (e.g. gigabytes of data) access by the third-party 206 and/or the fourth-party 208. In one example, information about access to customer account data includes information about an identity of the third-party 206. In one example, information about access to customer account data includes information about an identity of the fourth-party 208. In one example, information about access to customer account data includes information about identities in a chain of access (e.g. from the third-party 206 to the fourth-party 208.

When the customer is informed about access to their account data, they may want to change the permission of access. A customer may want to revoke or limit access to one third-party, but not another. A customer may want to revoke or limit access to which fields of data access is permitted by one or multiple third-parties. As shown in FIG. 1A, in one example, the user interface 103 includes selection options 107 that may be used to select or de-select individual fields 105. As noted above, after selecting one or more of the multiple fields 105 using selection options 107, an action button 109 may be used to act on the selected fields 105. Examples of actions effected by the action button 109 include, but are not limited to: “revoke access;” “suspend access;” “continue to allow access,” etc.

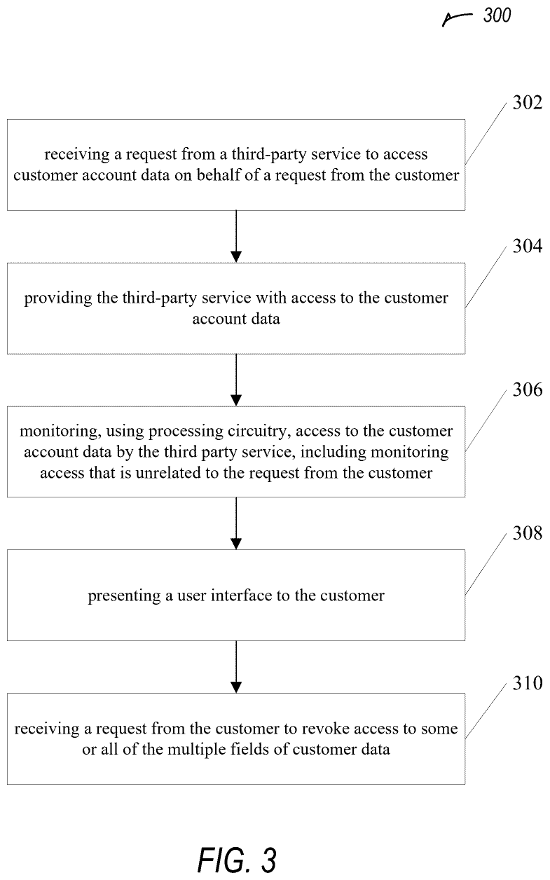

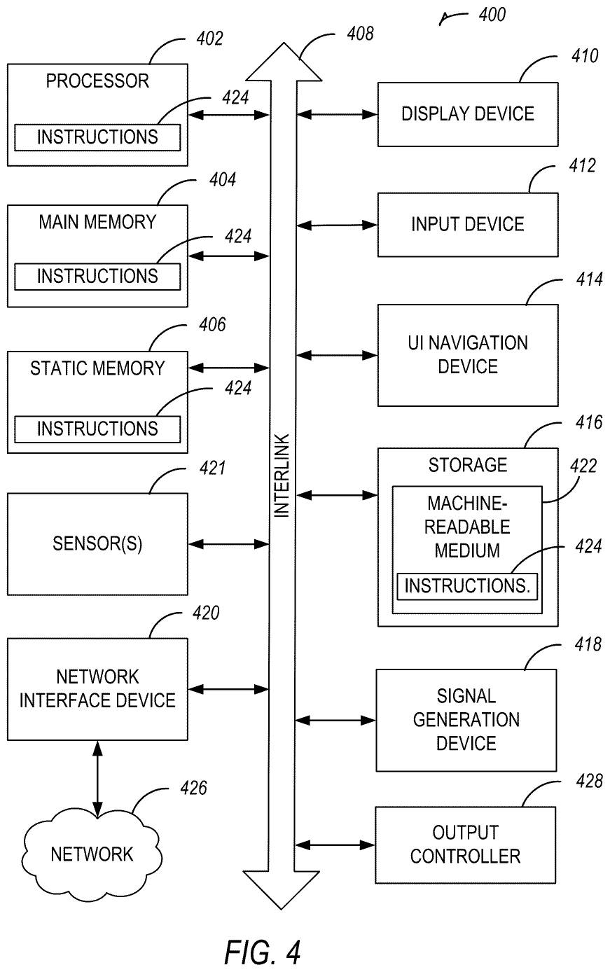

FIG. 3 illustrates a flowchart showing a technique 300 for monitoring and presenting a user interface to a customer in accordance with some embodiments. In an example, operations of the technique 300 may be performed by processing circuitry, for example by executing instructions stored in memory. The processing circuitry may include a processor, a system on a chip, or other circuitry (e.g., wiring). For example, the technique 300 may be performed by processing circuitry of a device (or one or more hardware or software components thereof), such as those illustrated and described with reference to FIG. 4.

In operation 302, a request is received from a third-party service to access customer account data on behalf of a request from the customer. In operation 304, the third-party service is provided with access to the customer account data. In operation 306, access to the customer account data by the third-party service is monitored using processing circuitry. In operation 306, monitoring includes monitoring access that is unrelated to the request from the customer. In operation 308, a user interface is presented to the customer. In one example, the user interface includes information about the access that is unrelated to the request from the customer. In one example, the user interface includes a control to change some or all access to multiple fields of customer data. In operation 310, a request is received from the customer to revoke access to some or all of the multiple fields of customer data.

In one example, at operation 308, the user interface further includes presenting information about a fourth-party service that is receiving the customer account data from the third-party service. In one example, at operation 308, the user interface further includes presenting information about different types of access to the customer account data by different third-party services. In one example, at operation 310, receiving the request from the customer to revoke access to some or all of the multiple fields of the customer account data includes receiving a request to revoke only a portion of access to a given third-party service. In one example, at operation 302, receiving the request from the third-party service includes receiving a request to access the customer account data on behalf of a mobile telephone app. In one example, at operation 302, receiving the request from the third-party service includes receiving a request to access the customer account data on behalf of a shopping app. In one example, at operation 302, receiving the request from the third-party service includes receiving a request to access the customer account data on behalf of a mortgage app. In one example, at operation 308, presenting the user interface further includes presenting information about a duration of access by the third-party service. In one example, at operation 308, presenting the user interface further includes presenting information about a number of access instances per time period by the third-party service. In one example, at operation 308, presenting the user interface further includes presenting information about an amount of data access by the third-party service.

FIG. 4 illustrates generally an example of a block diagram of a machine 400 upon which any one or more of the techniques (e.g., methodologies) discussed herein may perform in accordance with some embodiments. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, alphanumeric input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 that is non-transitory on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software.

The following, non-limiting examples, detail certain aspects of the present subject matter to solve the challenges and provide the benefits discussed herein, among others.

Aspect 1. A method comprising: receiving a request from a third-party service to access customer account data on behalf of a request from a customer; providing the third-party service with access to the customer account data; monitoring, using processing circuitry, access to the customer account data by the third-party service, including monitoring access that is unrelated to the request from the customer; presenting a user interface to the customer, the user interface including; information about the access that is unrelated to the request from the customer; a control to change some or all access to multiple fields of customer account data; receiving a request from the customer to revoke access to some or all of the multiple fields of the customer account data; and automatically revoking access by the third-party service to the some or all of the multiple fields of the customer account data in response to the request from the customer to revoke access.

Aspect 2. The method of aspect 1, wherein presenting the user interface further includes presenting information about a fourth-party service that is receiving the customer account data from the third-party service.

Aspect 3. The method of aspect 1, wherein presenting the user interface further includes presenting information about different types of access to the customer account data by different third-party services.

Aspect 4. The method of aspect 1, wherein receiving the request from the customer to revoke access to some or all of the multiple fields of the customer account data includes receiving a request to revoke only a portion of access to a given third-party service.

Aspect 5. The method of aspect 1, wherein receiving the request from the third-party service includes receiving a request to access the customer account data on behalf of a mobile telephone app.

Aspect 6. The method of aspect 1, wherein receiving the request from the third-party service includes receiving a request to access the customer account data on behalf of a shopping app.

Aspect 7. The method of aspect 1, wherein receiving the request from the third-party service includes receiving a request to access the customer account data on behalf of a mortgage app.

Aspect 8. The method of aspect 1, wherein presenting the user interface further includes presenting information about a duration of access by the third-party service.

Aspect 9. The method of aspect 1, wherein presenting the user interface further includes presenting information about a number of access instances per time period by the third-party service.

Aspect 10. The method of aspect 1, wherein presenting the user interface further includes presenting information about an amount of data access by the third-party service.

Aspect 11. At least one non-transitory machine-readable medium including instructions, which when executed by processing circuitry, causes the processing circuitry to perform operations to: receive a request from a third-party service to access customer account data on behalf of a request from a customer; provide the third-party service with access to the customer account data; monitor access to the customer account data by the third-party service, including monitoring access that is unrelated to the request from the customer; present a user interface to the customer, the user interface including; information about the access that is unrelated to the request from the customer; a control to change some or all access to multiple fields of customer account data; receive a request from the customer to revoke access to some or all of the multiple fields of the customer account data; and automatically revoke access by the third-party service to the some or all of the multiple fields of the customer account data in response to the request from the customer to revoke access.

Aspect 12. The at least one non-transitory machine-readable medium of aspect 11, wherein the processing circuitry to perform operations is further configured to present the user interface, including presenting information about a fourth-party service that is receiving the customer account data from the third-party service.

Aspect 13. The at least one non-transitory machine-readable medium of aspect 11, wherein the processing circuitry to perform operations is further configured to present the user interface, including presenting information about different types of access to the customer account data by different third-party services.

Aspect 14. The at least one non-transitory machine-readable medium of aspect 11, wherein the processing circuitry to perform operations is further configured to receive a request from the customer to revoke access only a portion of access to a given third-party service.

Aspect 15. The at least one non-transitory machine-readable medium of aspect 11, wherein the processing circuitry to receive the request from the third-party service is configured to receive a request to access customer account data on behalf of a mobile telephone app.

Aspect 16. The at least one non-transitory machine-readable medium of aspect 11, wherein the processing circuitry to receive the request from the third-party service is configured to receive a request to access customer account data on behalf of a shopping app.

Aspect 17. The at least one non-transitory machine-readable medium of aspect 11, wherein the processing circuitry to receive the request from the third-party service is configured to receive a request to access customer account data on behalf of a mortgage app.

Aspect 18. The at least one non-transitory machine-readable medium of aspect 11, wherein the processing circuitry to perform operations is further configured to present the user interface, including presenting information about a duration of access by the third-party service.

Aspect 19. The at least one non-transitory machine-readable medium of aspect 11, wherein the processing circuitry to perform operations is further configured to present the user interface, including presenting information about a number of access instances per time period by the third-party service.

Aspect 20. The at least one non-transitory machine-readable medium of aspect 11, wherein the processing circuitry to perform operations is further configured to present the user interface, including presenting information about an amount of data access by the third-party service.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
receiving a request from a third-party service to access customer account data on behalf of a request from a customer;
providing the third-party service with access to the customer account data;
monitoring, using processing circuitry, access to the customer account data by the third-party service, including monitoring access that is unrelated to the request from the customer;
presenting a user interface to the customer, the user interface including;
information about the access that is unrelated to the request from the customer;
a control to change some or all access to multiple fields of customer account data;
receiving a request from the customer to revoke access to some or all of the multiple fields of the customer account data; and
automatically revoking access by the third-party service to the some or all of the multiple fields of the customer account data in response to the request from the customer to revoke access.

2. The method of claim 1, wherein presenting the user interface further includes presenting information about a fourth-party service that is receiving the customer account data from the third-party service.

3. The method of claim 1, wherein presenting the user interface further includes presenting information about different types of access to the customer account data by different third-party services.

4. The method of claim 1, wherein receiving the request from the customer to revoke access to some or all of the multiple fields of the customer account data includes receiving a request to revoke only a portion of access to a given third-party service.

5. The method of claim 1, wherein receiving the request from the third-party service includes receiving a request to access the customer account data on behalf of a mobile telephone app.

6. The method of claim 1, wherein receiving the request from the third-party service includes receiving a request to access the customer account data on behalf of a shopping app.

7. The method of claim 1, wherein receiving the request from the third-party service includes receiving a request to access the customer account data on behalf of a mortgage app.

8. The method of claim 1, wherein presenting the user interface further includes presenting information about a duration of access by the third-party service.

9. The method of claim 1, wherein presenting the user interface further includes presenting information about a number of access instances per time period by the third-party service.

10. The method of claim 1, wherein presenting the user interface further includes presenting information about an amount of data access by the third-party service.

11. At least one non-transitory machine-readable medium including instructions, which when executed by processing circuitry, causes the processing circuitry to perform operations to:
receive a request from a third-party service to access customer account data on behalf of a request from a customer;
provide the third-party service with access to the customer account data;
monitor access to the customer account data by the third-party service, including monitoring access that is unrelated to the request from the customer;
present a user interface to the customer, the user interface including;
information about the access that is unrelated to the request from the customer;
a control to change some or all access to multiple fields of customer account data;
receive a request from the customer to revoke access to some or all of the multiple fields of the customer account data; and
automatically revoke access by the third-party service to the some or all of the multiple fields of the customer account data in response to the request from the customer to revoke access.

12. The at least one non-transitory machine-readable medium of claim 11, wherein the processing circuitry to perform operations is further configured to present the user interface, including presenting information about a fourth-party service that is receiving the customer account data from the third-party service.

13. The at least one non-transitory machine-readable medium of claim 11, wherein the processing circuitry to perform operations is further configured to present the user interface, including presenting information about different types of access to the customer account data by different third-party services.

14. The at least one non-transitory machine-readable medium of claim 11, wherein the processing circuitry to perform operations is further configured to receive a request from the customer to revoke access only a portion of access to a given third-party service.

15. The at least one non-transitory machine-readable medium of claim 11, wherein the processing circuitry to receive the request from the third-party service is configured to receive a request to access customer account data on behalf of a mobile telephone app.

16. The at least one non-transitory machine-readable medium of claim 11, wherein the processing circuitry to receive the request from the third-party service is configured to receive a request to access customer account data on behalf of a shopping app.

17. The at least one non-transitory machine-readable medium of claim 11, wherein the processing circuitry to receive the request from the third-party service is configured to receive a request to access customer account data on behalf of a mortgage app.

18. The at least one non-transitory machine-readable medium of claim 11, wherein the processing circuitry to perform operations is further configured to present the user interface, including presenting information about a duration of access by the third-party service.

19. The at least one non-transitory machine-readable medium of claim 11, wherein the processing circuitry to perform operations is further configured to present the user interface, including presenting information about a number of access instances per time period by the third-party service.

20. The at least one non-transitory machine-readable medium of claim 11, wherein the processing circuitry to perform operations is further configured to present the user interface, including presenting information about an amount of data access by the third-party service.
